(19) United States
(12) Patent Application Publication
(10) Pub. No.: US 2004/0023836 A1
(43) Pub. Date: Feb. 5, 2004

(54) Fabric care composition

(76) Inventors: David Moorfield, Merseyside (GB); Philip John Sams, Merseyside (GB); Ryan Simpson, Belfast (GB)

Correspondence Address: UNILEVER, PATENT DEPARTMENT, 45 RIVER ROAD, EDGEWATER, NJ, 07020, US

(21) Appl. No.: 10/363,148

(22) PCT Filed: Aug. 21, 2001
(86) PCT No.: PCT/EP01/09653

(30) Foreign Application Priority Data
Sep. 1, 2000 (GB) 0021482.5

(51) Int. Cl. C11D 3/37

(52) U.S. Cl. 510/475

(57) ABSTRACT

Polymers which are capable of self-cross-linking and/or of reacting with cellulose can be used in the treatment of fabric comprising cellulosic fibres to enhance the feeling of comfort when a garment comprising the fabric is worn. The enhanced feeling of comfort is due, at least in part, to an increase in the rate of moisture transport through the fabric. The polymers may be used in conjunction with a liquid or soft solid derivative of a cyclic polyol or of a reduced saccharide resulting from 35 to 100% of the hydroxyl groups in the polyol or the saccharide being esterified or etherified.

### TECHNICAL FIELD

This invention relates to the use of certain polymers to enhance the feeling of comfort when a garment is worn and to the use of the same polymers to increase the rate of moisture transport through a fabric. The invention also relates to fabric care compositions comprising the polymers and to methods of treating fabric with the compositions.

### BACKGROUND AND PRIOR ART

It is clearly desirable for garments to feel as comfortable as possible when they are worn. The feeling of comfort, which the wearer of a garment experiences, is a function of a whole host of different properties of the garment. For example, the softness of the garment, which can be increased by applying fabric softening and/or conditioning compounds to the fabric during the rinse cycle of a domestic laundering process, is one property that is important to the overall feeling of comfort.

Another measurable property of fabric, which is associated with comfort when a garment comprising the fabric is worn, is the rate of diffusion of water vapour through the fabric. It is normally desirable for water vapour, which evaporates from the skin to be able to diffuse through a garment as quickly as possible. High rates of diffusion through the fabric prevent the garment from feeling hot, wet and/or sticky. Similarly, it is desirable for a fabric to be able to absorb liquid moisture in order that the moisture can be transported away from the skin of the wearer of the fabric. If moisture is allowed to remain in contact with the skin, the fabric can again feel wet and, therefore, uncomfortable.

A number of documents, such as U.S. Pat. No 4,807,303, refer to improving the comfort of fabrics, although most of them rely on pre-treatments, which alter the physical and/or chemical construction of the fibres, which make up the fabric.

It is known that fluoropolymers can be applied to fabric and technology of this type is disclosed in WO 93/25279, U.S. Pat. Nos. 5,043,209 and 4,805,240. Treatment with fluoropolymers increases the hydrophobicity of the fabric, thus decreasing the tendency for it to feel wet, whilst still permitting water vapour to diffuse through the fabric.

Physical treatments of fabric can allow water vapour to pass through the fabric at an increased rate. For example, WO 92/17335 describes making pores in an impermeable laminate.

WO 95/33007 refers to adding particles of cross-linked polyacrylic acid salts to laminates to increase their ability to transmit water vapour.

The application to synthetic fabric of a combination of ester-acid or ester salt and amidic acid or amidic salt is disclosed in WO 93/07328. The polymers which are used in this treatment are non-cross-linked and they do not have the capability of self-cross-linking or of reacting with cellulose. The treatment is claimed to improve wetting/wicking characteristics of the fabric.

U.S. Pat. No. 4,910,069 mentions the treatment of fabric forming trouser pockets with a polyurethane, acrylic or silicone resin. The resins, when cured, are said to open up the fabric pores to allow transmission of water vapour.

The present invention aims to provide a system for enhancing the comfort of fabrics which does not require a physical or chemical treatment of the fabrics of the types described above.

It is a further aim of the present invention to provide a system for increasing the rate of diffusion of water vapour through fabrics.

The present invention also aims to provide a system for treating fabric to enhance comfort and/or increase the rate of moisture transport through the fabric which can be applied to fabric as part of a laundering process.

### DEFINITION OF THE INVENTION

According to the present invention, there is provided the use of a polymer which is capable of self-cross-linking and/or of reacting with cellulose in the treatment of fabric comprising cellulosic fibres to enhance the feeling of comfort when a garment comprising the fabric is worn.

Also provided by the invention is the use of a polymer which is capable of self-cross-linking and/or of reacting with cellulose in the treatment of fabric comprising cellulosic fibres to increase the rate of moisture transport through the fabric.

In another aspect, the invention relates to a fabric care composition comprising a polymer which is capable of self-cross-linking and/or of reacting with cellulose and a liquid or soft solid derivative of a cyclic polyol (CPE) or of a reduced saccharide (RSE) resulting from 35 to 100% of the hydroxyl groups in the polyol or saccharide bering esterified or etherified.

A further aspect of the invention is a method of treating a fabric, which comprises applying to-the fabric a composition of the invention as part of a laundering process.

### DETAILED DESCRIPTION OF THE INVENTION

The present invention uses polymers which are capable of self-cross-linking and/or of reacting with cellulose, to treat fabric, in order to enhance the feeling of comfort when a garment comprising the fabric is worn and/or to increase the rate of moisture transport through the fabric. It will be appreciated that increasing the rate of moisture transport through the fabric is one of the changes in the properties of the fabric which contribute to enhancing the feeling of comfort when a garment comprising the fabric is worn.

It was unexpected that polymers which are capable of self-cross-linking and/or of reacting with cellulose could increase the rate of moisture transport through a fabric. Even more surprising was the fact that the fabric can be treated with the polymer as part of a laundering process.

It will be appreciated that the term “moisture transport”, as used herein, refers to the transport of water in the gaseous and/or liquid state (ie, water vapour and/or liquid water).

Polymers which may be used in the invention include any polymer which is capable of self-cross-linking and/or of reacting with cellulose. Suitable polymers include non-ionic, amphoteric, cationic and anionic polymers.

Polymers which are suitable for use in the present invention are preferably capable of increasing the wet strength of paper by at least 200% compared to untreated paper when applied to paper having a weight of 80 g/m² at a level of 1% solids by weight based on weight of paper, according to the test method described hereinafter.

Anionic polymers which are suitable for use in the present invention include carbamoyl sulphonate terminated poly(ether)urethane resins, bunte salt terminated polymers and mixtures thereof. Examples of these types of polymers include those having the formula (I):

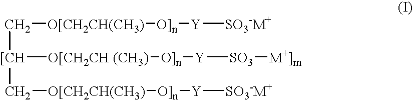

wherein:

Y is a divalent radical selected from —CH₂—CH(OH)—CH₂—S— and —CO—NH—(CH₂)ₚ—NH—CO—;

m is an integer from 0 to 4;

n is an integer from 5 to 20;

M is an alkali metal; and

p is an integer from 2 to 12.

Preferably, m is equal to 1.

Conveniently, Y is —CO—NH—(CH₂)ₚ—NH—CO— and, preferably, p is from 4 to 8, such as about 6.

It is also preferred that n is 10 to 15, such as about 13, for example.

M is advantageously sodium or potassium, more preferably sodium.

Polymers in which Y is —CO—NH—(CH₂)ₚ—NH—CO— are commercially available under the Trade Mark SYNTHAPPRET BAP (Bayer). Polymers in which Y is —CH₂—CH(OH)—CH₂—S— are available under the Trade Mark NOPCOLAN SHR3 (Henkel).

Cationic polymers, which are suitable for use in the present invention, include amine- or amide- epichlorohydrin resins or derivatives thereof. In the context of the present invention, these resins are polymeric, or at least oligomeric, in nature. Preferably, they have a weight average mean molecular weight of from 300 to 1,000,000 daltons. The resins of the invention are sometimes referred to below as amine-epichlorohydrin resins and polyamine-epichlorohydrin (PAE) resins (the two terms being used synonymously) although these terms encompass both the amine and amide resins of the invention. The resins may also have a mixture of amine and amide groups.

The amine or amide-epichlorohydrin resins may have one or more functional groups capable of forming azetidinium groups and/or one or more azetidinium functional groups.

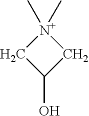

Alternatively, or additionally, the resins may have one or more functional groups that contain epoxide groups or derivatives thereof e.g. Kymene ₄₅₀™ (ex Hercules).

Suitable polyamine-epichlorohydrin (PAE) resins include those described in ‘Wet Strength Resins and Their Application’, pp 16-36, ed. L. L. Chan, Tappi Press, Atlanta, 1994. Suitable PAE resins can be identified by selecting those resins which impart increased wet strength to paper, after treatment, in a relatively simple test. Suitable PAE resins include Kenores 1440 (ex Akzo Nobel).

Any amine or amide-epichlorohydrin resin having an epoxide functional group or derivative thereof is suitable for use according to the invention.

A particularly preferred class of amine or amide-epichlorohydrin resins for use in the invention are secondary amine or amide-based azetidinium resins, for example, those resins derived from a polyalkylene polyamine e.g. diethylenetriamine (DETA), a polycarboxylic acid e.g. adipic acid or other dicarboxylic acids, and epichlorohydrin. Other polyamines or polyamides can also be advantageously used in the preparation of suitable PAE resins.

Another preferred class of amine-epichlorohydrin resins for use in the invention are those having an epoxide functional group or derivative thereof e.g. chlorohydrin.

The resins may be PDAA-epichlorohydrin resins or PMDAA-epichlorohydrin resins. PDAA is poly(diallylamine) and PMDAA is poly(methyldiallyl(amine)).

Other cationic polymers which can be used in the present invention include the polymers or prepolymers derived from polyoxyalkyleneamines that are described in U.S. Pat. No. 5,571,286, the contents of which are incorporated herein by reference. Methods for preparing the polymers are described in U.S. Pat. No. 5,571,286. Hence the polymers can be, for example, the reaction product of a diamine or triamine polyoxyalkylene prepolymer having a polymerisation degree of from 4 to 50 or a mixture thereof with epichlorohydrin in a ratio of epichlorohydrin to amino nitrogen of from 1:1 to 3:1. The amino groups in these polymers may be wholly or partly in the form of derivatives of amino groups. Derivatives include, for example, adducts formed by alkylation or hydroxyalkylation at the nitrogen atom or by the formation of an amide group at the nitrogen atom. The derivatives may be formed by the reaction of the amino groups with a bifunctional bridging agent or with a cross-linking agent. Preferably, the polymers are obtainable by the reaction of a prepolymer of formula B(R)n, wherein n is from 1 to 20, B is a backbone group to which each R is covalently bonded and R is a group comprising a poly(oxyalkylene) chain, which chain comprises an amino end group, the polymer being optionally reacted with a bridging compound, with a cross-linking agent. It will thus be appreciated that the polymer may be a relatively complex mixture comprising a number of different compounds, some or all of, which may be cross-linked.

The poly(oxyalkylene) chain which forms a part of the R group may be, for example a poly(oxyethylene) or poly(oxyprop-l,2-ylene) chain. The length of the chain can vary from 2 to 100 repeat units.

Conveniently, n is 2 or 3. It will be appreciated that n may not be a whole number where the polymer is formed from a mixture of different polymers of formula B(R)ₙ.

In some of the polymers which may be used in the invention, B is

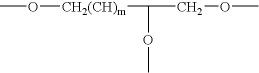

(ie, B is the residue of glycerol) and m is equal to n-2.

However, B can also represent other values such as, for example, the residue of other triols or the residue of a di-, tetra-, penta- or hexa- hydroxy compound. Alternatively, B can represent the residue of a di-, tri- or poly- amine.

Preferably, at least one R group has the formula—(CH₂CH(R′)O) P—A—NHR″, wherein R′ is H or CH₃ , p is an integer from 5 to 30, A is an alkylene group and R″ is H or alkyl. More preferably, p is from 10 to 25.

The term “alkyl”, as used herein, includes C₁ to C₆ alkyl, optionally substituted on the alkyl chain, which may be branched or unbranched and, for C₃ to C₆ alkyl, may be cyclic. The term “alkylene” is defined similarly but refers to a divalent radical.

It will be appreciated that the term “end group” refers to the group at or near to the end of the poly(oxyalkylene) chain, which end, when the prepolymer is of formula B(R)ₙ, is at the other end of the prepolymer chain from the end which is attached to B.

Suitable prepolymers of formula B(R)ₙ, include those having the following structure:

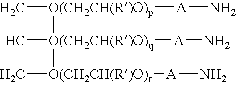

wherein R′ is as defined hereinbefore, p, q and r are integers which may be the same or different and may be from 5 to 30 and A is branched or unbranched lower alkylene.

The cross-linking agent which is used to form the polymer by reaction with the prepolymer, or the prepolymer after prior reaction with the bridging compound, preferably comprises an epihalohydrin. Epichlorohydrin is a suitable epihalohydrin.

Preferably the molar ratio of cross-linking agent to prepolymer of formula B(R)n is from 0.5:1 to 4:1. Other amounts of cross-linking agent may be used to form the polymers.

Suitable bridging compounds comprise two epoxide or carboxylic acid groups. The epoxide or carboxylic acid groups may be linked by a linker comprising alkylene, arylene, poly(oxyalkylene) or siloxane groups or combinations thereof. Examples of bridging compounds therefore include benzene-1,4-dicarboxylic acid, hexane-1,6-dicarboxylic acid and poly(oxyethylene) compounds terminated at both ends of the molecule by an epoxide group. Other suitable bridging compounds are disclosed in U.S. Pat. No. 5,571,286.

Polymers which are suitable for use in the present invention are available from Precision Processes Textiles (Ambergate, Derbyshire, UK) under the trade marks POLYMER AM and POLYMER MRSM. The polymers are preferably in the form of aqueous solutions.

The treatment of fabric with a polymer according to the invention is preferably carried out as part of a laundering process. When the treatment is carried out as part of a laundering process, the polymer may be used in the form of a composition comprising the polymer and one or more textile compatible carriers. The composition may be a fabric care composition of the invention, which comprises a CPE or RSE, as described herein, or a composition which comprises one or more other textile compatible carriers.

The nature of the textile compatible carrier will be dictated to a large extent by the stage at which the composition is used in a laundering process, the compositions being capable of being used, in principle, at any stage of the process. For example, where the compositions are for use as main wash detergent compositions, the one or more textile compatible carriers comprise a detergent active compound. Where the compositions are for use in the rinsing step (or cycle) of a laundering process, which is preferred, the one or more textile compatible carriers may comprise a fabric softening and/or conditioning compound.

The compositions of the invention preferably comprise a perfume, such as of the type which is conventionally used in fabric care compositions. The compositions may be packaged and labelled for use in a domestic laundering process.

The polymer is preferably present used in a sufficient quantity to give an amount of 0.0005% to 5% by weight on the fabric based on the weight of the fabric (owf), more preferably 0.001% to 2% by weight on fabric. The amount of the polymer in the composition required to achieve the above % by weight on fabric will typically be in the range 0.01% to 35% by weight, preferably 0.1 to 13.5% by weight.

The polymers of the invention, when applied to a fabric, can impart benefits to the fabric when uncured. However, they may be cured by a domestic curing step including ironing and/or domestic tumble drying, preferably tumble-drying. The curing is preferably carried out at a temperature in the range of from 50 to 100° C., more preferably from 80 to 100° C.

In the context of the present invention the term “textile compatible carrier” is a component which can assist in the interaction of the first component with the fabric. The carrier can also provide benefits in addition to those provided by the first component e.g. softening, cleaning etc. The carrier may be water, in which case the composition of the invention may contain another additive, such as perfume, for example, or the carrier may be a detergent-active compound or a fabric softener or conditioning compound or other suitable detergent or fabric treatment agent.

If the polymer is to be used according to the invention in a laundry process as part of a conventional fabric treatment product, such as a detergent composition, the textile-compatible carrier will typically be a detergent-active compound. Whereas, if the fabric treatment product is a rinse conditioner, the textile-compatible carrier will be a fabric softening and/or conditioning compound.

If the invention is to be carried out before, or after, the laundry process the polymer may be contained in a composition which is in the form of a spray or foaming product.

The fabrics, which may be treated in the present invention, include those which comprise cellulosic fibres, preferably from 1% to 100% cellulosic fibres (more preferably 5% to 100% cellulosic fibres, most preferably 40% to 100%). The fabric may be in the form of a garment, in which case the method of the invention may represent a method of laundering a garment. When the fabric contains less than 100% cellulosic fibres, the balance comprises other fibres or blends of fibres suitable for use in garments such as polyester, for example. Preferably, the cellulosic fibres are of cotton or regenerated cellulose such as viscose.

The laundering processes of the present invention include the large scale and small scale (eg domestic) cleaning of fabrics. Preferably, the processes are domestic.

In the invention, the polymer or the composition of the invention may be used at any stage of the laundering process. Preferably, the composition or the polymer is used to treat the fabric in the rinse cycle of a laundering process. The rinse cycle preferably follows the treatment of the fabric with a detergent composition.

Detergent Active Compounds

If the present invention is carried out using the polymer in the form of a detergent composition, the textile-compatible carrier may be chosen from soap and non-soap anionic, cationic, nonionic, amphoteric and zwitterionic detergent active compounds, and mixtures thereof.

Many suitable detergent active compounds are available and are fully described in the literature, for example, in “Surface-Active Agents and Detergents”, Volumes I and II, by Schwartz, Perry and Berch.

The preferred textile-compatible carriers that can be used are soaps and synthetic non-soap anionic and nonionic compounds.

Anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

Cationic surfactants that may be used include quaternary ammonium salts of the general formula R₁R₂R₃R₄N⁺X⁻ wherein the R groups are independently hydrocarbyl chains of C₁-C₂₂ length, typically alkyl, hydroxyalkyl or ethoxylated alkyl groups, and X is a solubilising cation (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters) and pyridinium salts.

The total quantity of detergent surfactant in the composition is suitably from 0.1 to 60 wt % e.g. 0.5-55 wt %, such as 5-50wt %.

Preferably, the quantity of anionic surfactant (when present) is in the range of from 1 to 50% by weight of the total composition. More preferably, the quantity of anionic surfactant is in the range of from 3 to 35% by weight, e.g. 5 to 30% by weight.

Preferably, the quantity of nonionic surfactant when present is in the range of from 2 to 25% by weight, more preferably from 5 to 20% by weight.

Amphoteric surfactants may also be used, for example amine oxides or betaines.

The detergent compositions may suitably contain from 10 to 70%, preferably from 15 to 70% by weight, of detergency builder. Preferably, the quantity of builder is in the range of from 15 to 50% by weight.

The detergent compositions may contain as builder a crystalline aluminosilicate, preferably an alkali metal aluminosilicate, more preferably a sodium aluminosilicate.

The aluminosilicate may generally be incorporated in amounts of from 10 to 70% by weight (anhydrous basis), preferably from 25 to 50%. Aluminosilicates are materials having the general formula:

0.8-1.5 M₂O. Al₂O₃. 0.8-6 SiO₂

where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature.

Fabric Softening and/or Conditioner Compounds

If the polymer is used in the present invention in the form of a fabric conditioner composition, the textile-compatible carrier will be a fabric softening and/or conditioning compound (hereinafter referred to as “fabric softening compound”), which may be a cationic or nonionic compound.

The softening and/or conditioning compounds may be water insoluble quaternary ammonium compounds. The compounds may be present in amounts of up to 8% by weight (based on the total amount of the composition) in which case the compositions are considered dilute, or at levels from 8% to about 50% by weight, in which case the compositions are considered concentrates.

Compositions suitable for delivery during the rinse cycle may also be delivered to the fabric in the tumble dryer if used in a suitable form. Thus, another product form is a composition (for example, a paste) suitable for coating onto, and delivery from, a substrate e.g. a flexible sheet or sponge or a suitable dispenser during a tumble dryer cycle.

Suitable cationic fabric softening compounds are substantially water-insoluble quaternary ammonium materials comprising a single alkyl or alkenyl long chain having an average chain length greater than or equal to C₂₀ or, more preferably, compounds comprising a polar head group and two alkyl or alkenyl chains having an average chain length greater than or equal to C₁₄. Preferably the fabric softening compounds have two long chain alkyl or alkenyl chains each having an average chain length greater than or equal to C₁₆. Most preferably at least 50% of the long chain alkyl or alkenyl groups have a chain length of C₁₈ or above. It is preferred if the long chain alkyl or alkenyl groups of the fabric softening compound are predominantly linear.

Quaternary ammonium compounds having two long-chain aliphatic groups, for example, distearyldimethyl ammonium chloride and di(hardened tallow alkyl) dimethyl ammonium chloride, are widely used in commercially available rinse conditioner compositions. Other examples of these cationic compounds are to be found in “Surface-Active Agents and Detergents”, Volumes I and II, by Schwartz, Perry and Berch. Any of the conventional types of such compounds may be used in the compositions of the present invention.

The fabric softening compounds are preferably compounds that provide excellent softening, and are characterised by a chain melting Lβ to Lα transition temperature greater than 25° C., preferably greater than 35° C., most preferably greater than 45° C. This Lβ to Lα transition can be measured by DSC as defined in “Handbook of Lipid Bilayers”, D Marsh, CRC Press, Boca Raton, Fla., 1990 (pages 137 and 337).

Substantially water-insoluble fabric softening compounds are defined as fabric softening compounds having a solubility of less than 1×10⁻³ wt % in demineralised water at 20° C. Preferably the fabric softening compounds have a solubility of less than 1×10⁻⁴ wt %, more preferably less than 1×10⁻⁸ to 1×10⁻⁶ wt %.

Especially preferred are cationic fabric softening compounds that are water-insoluble quaternary ammonium materials having two C₁₂-₂₂ alkyl or alkenyl groups connected to the molecule via at least one ester link, preferably two ester links. An especially preferred ester-linked quaternary ammonium material can be represented by the formula II:

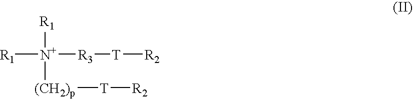

wherein each R₁ group is independently selected from C₁₋₄ alkyl or hydroxyalkyl groups or C₂₋₄ alkenyl groups; each R₂ group is independently selected from C₈₋₂₈ alkyl or alkenyl groups; and wherein R₃ is a linear or branched alkylene group of 1 to 5 carbon atoms, T is

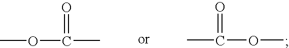

and p is 0 or is an integer from 1 to 5.

Di(tallowoxyloxyethyl) dimethyl ammonium chloride and/or its hardened tallow analogue is especially preferred of the compounds of formula (II).

A second preferred type of quaternary ammonium material can be represented by the formula (III):

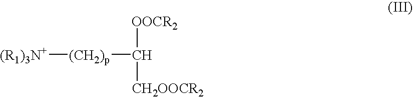

wherein R₁, p and R₂ are as defined above.

It is advantageous if the quaternary ammonium material is biologically biodegradable.

Preferred materials of this class such as 1,2-bis(hardened tallowoyloxy) -3-trimethylammonium propane chloride and their methods of preparation are, for example, described in U.S. Pat. No. 4,137,180 (Lever Brothers Co). Preferably these materials comprise small amounts of the corresponding monoester as described in U.S. Pat. No. 4,137,180, for example, 1-hardened tallowoyloxy-2-hydroxy-3-trimethylammonium propane chloride.

Other useful cationic softening agents are alkyl pyridinium salts and substituted imidazoline species. Also useful are primary, secondary and tertiary amines and the condensation products of fatty acids with alkylpolyamines.

The compositions may alternatively or additionally contain water-soluble cationic fabric softeners, as described in GB 2 039 556B (Unilever).

The compositions may comprise a cationic fabric softening compound and an oil, for example as disclosed in EP-A-0829531.

The compositions may alternatively or additionally contain nonionic fabric softening agents such as lanolin and derivatives thereof.

Lecithins are also suitable softening compounds.

Nonionic softeners include Lβ phase forming sugar esters (as described in M Hato et al Langmuir 12, 1659, 1666, (1996)) and related materials such as glycerol monostearate or sorbitan esters. Often these materials are used in conjunction with cationic materials to assist deposition (see, for example, GB 2 202 244). Silicones are used in a similar way as a co-softener with a cationic softener in rinse treatments (see, for example, GB 1 549 180).

The compositions may also suitably contain a nonionic stabilising agent. Suitable nonionic stabilising agents are linear C₈ to C₂₂ alcohols alkoxylated with 10 to 20 moles of alkylene oxide, C₁₀ to C₂₀ alcohols, or mixtures thereof.

Advantageously the nonionic stabilising agent is a linear C₈ to C₂₂ alcohol alkoxylated with 10 to 20 moles of alkylene oxide. Preferably, the level of nonionic stabiliser is within the range from 0.1 to 10% by weight, more preferably from 0.5 to 5% by weight, most preferably from 1 to 4% by weight. The mole ratio of the quaternary ammonium compound and/or other cationic softening agent to the nonionic stabilising agent is suitably within the range from 40:1 to about 1:1, preferably within the range from 18:1 to about 3:1.

The composition can also contain fatty acids, for example C₈ to C₂₄ alkyl or alkenyl monocarboxylic acids or polymers thereof. Preferably saturated fatty acids are used, in particular, hardened tallow C₁₆ to C₁₈ fatty acids. Preferably the fatty acid is non-saponified, more preferably the fatty acid is free, for example oleic acid, lauric acid or tallow fatty acid. The level of fatty acid material is preferably more than 0.1% by weight, more preferably more than 0.2% by weight. Concentrated compositions may comprise from 0.5 to 20% by weight of fatty acid, more preferably 1% to 10% by weight. The weight ratio of quaternary ammonium material or other cationic softening agent to fatty acid material is preferably from 10:1 to 1:10.

The fabric conditioning compositions may include silicones, such as predominately linear polydialkylsiloxanes, e.g. polydimethylsiloxanes or aminosilicones containing amine-functionalised side chains; soil release polymers such as block copolymers of polyethylene oxide and terephthalate; amphoteric surfactants; smectite type inorganic clays; zwitterionic quaternary ammonium compounds; and nonionic surfactants.

The fabric conditioning compositions may also include an agent, which produces a pearlescent appearance, e.g. an organic pearlising compound such as ethylene glycol distearate, or inorganic pearlising pigments such as microf ine mica or titanium dioxide (TiO₂) coated mica.

The fabric conditioning compositions may be in the form of emulsions or emulsion precursors thereof.

Other optional ingredients include emulsifiers, electrolytes (for example, sodium chloride or calcium chloride) preferably in the range from 0.01 to 5% by weight, pH buffering agents, and perfumes (preferably from 0.1 to 5% by weight).

Further optional ingredients include non-aqueous solvents, perfume carriers, fluorescers, colourants, hydrotropes, antifoaming agents, antiredeposition agents, enzymes, optical brightening agents, opacifiers, dye transfer inhibitors, anti-shrinking agents, anti-wrinkle agents, anti-spotting agents, germicides, fungicides, anti-oxidants, UV absorbers (sunscreens), heavy metal sequestrants, chlorine scavengers, dye fixatives, anti-corrosion agents, drape imparting agents, antistatic agents and ironing aids. This list is not intended to be exhaustive.

Fabric Care Compositions of The Invention

The fabric care compositions of the invention are fabric softening and/or conditioner compounds, of the type described hereinabove, which comprise a liquid or soft solid derivative of a cyclic polyol (CPE) or of a reduced saccharide (RSE) resulting from 35 to 100% of the hydroxyl groups in the polyol or saccharide being esterified or etherified. The CPEs or RSEs have 2 or more ester or ether groups independently attached to a C₈-C₂₂ alkyl or alkenyl chain, wherein at least one of the chains attached to the ester or ether groups has at least one saturated bond.

It has surprisingly been found that the use of one or more CPEs or RSEs (such as sucrose esters) together with a polymer which is capable of self-cross-linking and/or of reacting with cellulose can give greater benefits than the polymer alone in enhancing the feeling of comfort when a garment comprising the fabric is worn.

The CPE or RSE used according to the invention does not have any substantial crystalline character at 20° C. Instead it is preferably in a liquid or soft solid state as herein defined at 20° C.

The liquid or soft solid (as hereinafter defined) CPEs or RSEs of the present invention result from 35 to 100% of the hydroxyl groups of the starting cyclic polyol or reduced saccharide being esterified or etherified with groups such that the CPEs or RSEs are in the required liquid or soft solid state. These groups typically contain unsaturation, branching or mixed chain lengths.

Typically the CPE's or RSE's have 3 or more ester or ether groups or mixtures thereof, for example 3 to 8, eg 3 to 5. It is preferred if two or more of the ester or ether groups of the CPE or RSE are independently of one another attached to a C₈ to C₂₂ alkyl or alkenyl chain. The C₈ to C₂₂ alkyl or alkenyl groups may be branched or linear carbon chains.

Preferably 35 to 85% of the hydroxyl groups, most preferably 40-80%, even more preferably 45-75%, such as 45-70% are esterified or etherified.

Preferably the CPE or RSE contains at least 35% tri or higher esters, eg, at least 40%.

The CPE or RSE has at least one of the chains independently attached to the ester or ether groups having at least one unsaturated bond. This provides a cost effective way of making the CPE or RSE a liquid or a soft solid. It is preferred if predominantly unsaturated fatty chains are attached to the ester/ether groups, e.g. those attached are defined from rape oil, cotton seed oil, soybean oil, oleic, tallow, palmitoleic, linoleic, erucic or other sources of unsaturated vegetable fatty acids.

These chains are referred to below as the ester or ether chains (of the CPE or RSE).

The ester or ether chains of the CPE or RSE are preferably predominantly unsaturated. The most preferred CPEs or RSEs are those with monosaturated fatty acid chains, i.e. where any polyunsaturation has been removed by partial hydrogenation. Preferred CPEs or RSEs include sucrose tetratallowate, sucrose tetrarapeate, sucrose tetraoleate, sucrose tetraesters of soybean oil or cotton seed oil, cellobiose tetraoleate, sucrose trioleate, sucrose triapeate, sucrose pentaoleate, sucrose pentarapeate, sucrose hexaoleate, sucrose hexarapeate, sucrose triesters, pentaesters and hexaesters of soybean oil or cotton seed oil, glucose tiroleate, glucose tetraoleate, xylose trioleate, or sucrose tetra-,tri-, penta- or hexa- esters with any mixture of predominantly unsaturated fatty acid chains. However some CPEs or RSEs based on polyunsaturated fatty acid chains, eg sucrose tetralinoleate, may be used provided most of the polyunsaturation has been removed by partial hydrogenation.

The most highly preferred liquid CPEs or RSEs are any of the above but where the polyunsaturation has been removed through partial hydrogenation.

Preferably 40% or more of the fatty acid chains contain an unsaturated bond, more preferably 50% or more, most preferably 60% or more. In most cases 65% to 100%, eg 65% to 95% contain an unsaturated bond.

CPEs are preferred for use with the present invention. Inositol is a preferred example of a cyclic polyol. Inositol derivatives are especially preferred.

In the context of the present invention the term cyclic polyol encompasses all forms of saccharides. Indeed saccharides are especially preferred for use with this invention. Examples of preferred saccharides for the CPE's or RSE's to be derived from are monosaccharides and disaccharides.

Examples of monosaccharides include xylose, arabinose, galactose, fructose, sorbose and glucose. Glucose is especially preferred. An example of a reduced saccharide is sorbitan. Examples of disaccharides include maltose, lactose, cellobiose and sucrose. Sucrose is especially preferred.

The liquid or soft solid CPE's can be prepared by methods well known to those skilled in the art. These include acylation of the cyclic polyol or reduced saccharide with an acid chloride; trans-esterification of the cyclic polyol or reduced saccharide fatty acid esters using a variety of catalysts; acylation of the cyclic polyol or reduced saccharide with an acid anhydride and acylation of the cyclic polyol or reduced saccharide with a fatty acid. See for instance U.S. Pat. No. 4,386,213 and AU 14416/88 (Procter and Gamble).

It is preferred if the CPE or RSE has 3 or more, preferably 4 or more ester or ether groups. If the cyclic CPE is a disaccharide it is preferred if the disaccharide has 3 or more ester or ether groups. Particularly preferred CPE's are esters with a degree of esterification of 3 to 5, for example, sucrose tri, tetra and penta esters.

Where the cyclic polyol is a reducing sugar it is advantageous if each ring of the CPE has one ether group, preferably at the C₁ position. Suitable examples of such compounds include methyl glucose derivatives.

Examples of suitable CPEs include esters of alkyl(poly)glucosides, in particular alkyl glucoside esters having a degree of polymerisation from 1 to 2.

The length of the unsaturated (and saturated if present) chains in the CPE or RSE is C₈-C₂₂, preferably C₁₂-C₂₂. It is possible to include one or more chains of C₁-C₈, however these are less preferred.

The liquid or soft solid CPE's or RSE's of the present invention are characterised as materials having a solid:liquid ratio of between 50:50 and 0:100 at 20° C. as determined by T₂ relaxation time NMR, preferably between 43:57 and 0:100, most preferably between 40:60 and 0:100, such as, 20:80 and 0:100. The T₂ NMR relaxation time is commonly used for characterising solid:liquid ratios in soft solid products such as fats and margarines. For the purpose of the present invention, any component of the signal with a T₂ of less than 100 μs is considered to be a solid component and any component with T₂>100 μs is considered to be a liquid component.

For the CPE's and RSE's the tetra, penta etc prefixes only indicate the average degrees of esterification. The compounds exist as a mixture of materials ranging from the monoester to the fully esterified ester. It is the average degree of esterification which is used herein to define the CPE's and RSE's.

The HLB of the CPE or RSE is typically between 1 and 3.

The CPE or RSE is preferably present in the composition in an amount of 0.5-50% by weight based upon the total weight of the composition, more preferably 1-30% by weight, such as 2-25%, eg 2-20%.

The CPEs and RSEs for use in the compositions include those recited in the following examples, including, sucrose pentaoleate, sucrose tetraoleate, sucrose pentaerucate, sucrose tetraerucate and sucrose pentaoleate.

Fabric Treatment Products

The composition of the invention may be in the form of a liquid, solid (e.g. powder or tablet), a gel or paste, spray, stick or a foam or mousse. Examples including a soaking product, a rinse treatment (e.g. conditioner or finisher) or a mainwash product. The composition may also be applied to a substrate e.g. a flexible sheet or used in a dispenser which can be used in the wash cycle, rinse cycle or during the dryer cycle.

The invention will now be described by way of example only and with reference to the following non-limiting examples.

### EXAMPLES

### Examples 1 to 3

General Procedure

(a) Preparation of Fabric

Knitted cotton (Pheonix Calico, Macclesfield, UK) was cut into sheets approximately 1 m×1.7 m. The sheets (10 sheets/load) were washed once with detergent (Persil Non-Biological (trade mark) 90 g) in a top loading washing machine (9605 Hotpoint (trade mark) using a 60° C. cotton wash cycle). They were washed a further three times using a 40° C. woollen cycle in the absence of detergent. The sheets were dried in a tumble drier (Novotronic T430 (trade mark) Miele, Germany) at approximately 65° C. and stored under ambient conditions prior to treatment with polymers.

(b) Treatment of fabric

Fabric samples (approximately 50 cm×85 cm, 55 g) were cut from the sheets. The samples were treated with the following polymers:

Example 1—cationic polyamide-epichlorohydrin azetidinium functional polymer (PAE), Kenores 1440 (trade mark) ex Akzo Nobel;

Example 2—adduct of an isocyanate-terminated polyurethane (SBAP), Synthappret BAP (trade mark) ex Bayer;

Example 3—cationic polyoxyalkylene-based azetidium functional polymer (AM), Polymer AM (trade mark) ex Precision Processes Textiles Ltd, Ambergate, UK.

The polymers were pad applied to the fabric samples (20° C., 100 wet pick-up) to a yield a final concentration of 2% on weight of fabric (owf). Samples padded with demineralised water acted as controls. Treated samples were cured in an oven (Plus II Oven, Gallenkamp, Germany) at 110° C. for 45 min before being ironed lightly (cool cotton setting). Samples were conditioned in a humidity room (20° C., 65% relative humidity (RH)) for a minimum of 24 hours prior to testing for moisture transport properties.

(c) Fabric Testing

Three tests were used to measure the moisture transport properties of the fabric; wicking, spreading drop and upright cup. All tests were performed in a humidity room at 20° C., 65% RH.

Wicking Test

Fabric strips (20 cm×3 cm) were held longitudinally in a clamp. The free end of each strip was weighted with a paper clip (0.2g). The strips were lowered into a trough containing demineralised water (11) so that the bottom 0.5cm of the fabric was submerged. The wicking height was measured as the maximum distance travelled by the water up the strip after 15 minutes.

Spreading Drop Test

Fabric circles (9 cm diameter) were placed on a glass plate. Demineralised water (0.2 ml) was pipetted drop-wise onto the centre of the fabric circle. The wetted area was measured at its widest point after 3 min.

Upright Cup Test

Fabric circles (9 cm diameter) were placed over the top of a polyethylene cup containing demineralised water (170 ml). The fabric was held firmly in place with a polyethylene ring which formed a tight seal between the fabric and the cup. The cups were placed on a turntable which was rotated at 33 revolutions per minute (rpm) and air was blown over the surface of the fabric (2.5 m/s) using a fan. Moisture vapour transport through the fabric was measured by calculating the weight of water lost from the cup after 24 h.

The wicking and spreading drop tests were performed in triplicate for each sample. The upright cup test was performed in duplicate for each sample. The entire procedure was carried out on three separate occasions.

Results

| Wicking test | | |
|---|---|---|
| | | Average height |
| | Sample | (mm) |
| Control | Untreated | 145.56 |
| Example 1 | PAE (2%) | 146.25 |
| Example 2 | SBAP (2%) | 143.11 |
| Example 3 | AM (2%) | 172.78 |
| Spreading drop test | | |
| | | Average width of |
| | Sample | wetted area (mm) |
| Control | untreated | 39.67 |
| Example 1 | PAE (2%) | 40.58 |
| Example 2 | SEAP (2%) | 43.11 |
| Example 3 | AM (2%) | 49.00 |
| Upright cup test | | |
| | | Average weight |
| | Sample | loss (g/m²/day) |
| Control | Untreated | 690.67 |
| Example 1 | PAE (2%) | 726.16 |
| Example 2 | SBAP (2%) | 706.08 |
| Example 3 | AM (2%) | 765.57 |

Thus, treatment of the fabric according to Examples 1 to 3 had the effect of increasing water vapour transport through the fabric. The hydrophilicity of the fabric was also generally increased, as demonstrated by the results for the wicking test and the spreading drop test.

### Examples 4 to 6

Delivery of Compositions During the Rinse Cycle

Fabric Preparation and Treatment

Fabric (69% cotton, 31% polyester) was cut into sheets approximately 1 m×1 m and overlooked. Three sheets were weighted and placed in a Miele (trade mark) European front-loading washing machine. Ballast (strips of surplus fabric) was added to bring the total load weight up to 1.5 kg. Detergent (Persil Non-Biological (trade mark), 55g) was poured into the main-wash compartment of the dispensing drawer and the wash cycle initiated. The machines were filled with 12.11 of water and the fabric was washed for 30 min at 40° C. A further 3.71 of water was added before the wash load was drained. The fabric was rinsed three times (10.51 water/rinse) and drained. The wash cycle was paused and appropriate quantities of rinse treatment (Polymer AM (AM), Hamburg Ester Quaternary ie, 1,2,-bis [hardened tallowoyloxy]-3-trimethylammonium-propane chloride (HEQ)+AM, or sucrose polyerucate (SPE)+AM were poured into the main-wash compartment of the dispensing drawer. The wash cycle was initiated once more. Water (10.71) was introduced, and the wash load agitated for 5 min. The water was drained and the fabric spin-dried.

Fabric was removed from the washing machine and dried in a tumble drier (Novotronic T430 (trade mark), Miele (trade mark)) at approximately 65° C.

The procedure was repeated on twelve separate occasions for each load of fabric.

Fabric was conditioned in a humidity room (20° C., 65% relative humidity) for a minimum of 24 h prior to testing for moisture transport properties.

Definition of Treatments

Sucrose polyerucate (average degree of esterification=4.5-5.0%) ER 290 Ex Mitsubishi-Kagaku Foods Corporation, Tokyo, Japan

HEQ was applied as Comfort (trade mark) concentrate (European formulation)—12.5% HEQ.

Fabric Testing

Test protocols as outlined previously for Examples 1 to 3.

Results

| Wicking Test | | |
|---|---|---|
| | | Average height |
| | Sample | (mm) |
| Control 2 | Untreated | 159.0 |
| Example 4 | AM (0.2% owf) | 173.8 |
| Example 5 | AM (0.2% owf) + | 24.5 |
| | HEQ (0.2% owf) | |
| Example 6 | AM (0.2% owf) + SPE | 161.8 |
| | (0.2% owf) | |
| Spreading Drop Test | | |
| | | Average Width of |
| | Sample | Wetted Area (mm) |
| Control 2 | Untreated | 41.5 |
| Example 4 | AM (0.2% owf) | 45.1 |
| Example 5 | AM (0.2% owf) + | 27.5 |
| | HEQ (0.2% owf) | |
| Example 6 | AM (0.2% owf) + | 42.9 |
| | SPE (0.2% owf) | |

The results show that the use of a self-cross-linking polymer in conjunction with a sucrose ester gives improvements in the moisture transport of the treated fabric. These improvements are not realised when the polymer is used together with HEQ.

### Example 7

A fabric softening composition according to the invention was prepared by formulating together the following components:

| | |
|---|---|
| Sucrose polyerucate (ER 290) | 3.1% w/v |
| Cetyl trimethylammonium chloride (Aldrich) | 0.3% w/v |
| Polymer AM (PPT) | 3.1% w/v |
| Perfume | trace |
| Demineralised water | balance |

1. Use of a composition comprising a polymer, which is capable of self-cross-linking and/or of reacting with cellulose, and a liquid or soft solid derivative of a cyclic polyol (CPE) or of a reduced saccharide (RSE) resulting from 35 to 100% of the hydroxyl groups in the polyol or saccharide being esterified or etherified in the treatment of fabric comprising cellulosic fibres to enhance the feeling of comfort when a garment comprising the fabric is worn.

2. Use of a polymer which is capable of self-cross-linking and/or of reacting with cellulose wherein the polymer is the reaction product of a prepolymer comprising amino functional groups with epichlorohydrin in the treatment of fabric comprising cellulosic fibres to increase the rate of moisture transport through the fabric.

3. Use as claimed in claim 1 or claim 2, wherein the fabric comprises cotton.

4. Use as claimed in claim 2 or 3, wherein the polymer is a polyaxminoamide-epichlorohydrin (PAE) resin.

5. Use as claimed in claim 4, wherein the prepolymer comprises one or more poly(oxyalkylene) groups and one or more amino groups or derivatives of said amino groups.

6. Use as claimed in any one of claims 1 to 5, wherein the fabric is treated with the polymer as part of a laundering process.

7. Use as claimed in claim 6, wherein the fabric is treated with the polymer during the rinsing cycle of a laundering process.

8. Use as claimed in any one of claims 2 to 7, wherein the fabric is treated with a composition comprising the polymer and one or more textile compatible carriers.

9. Use as claimed in claim 8, wherein the one or more textile compatible carriers comprise a fabric softening and/or conditioning compound.

10. Use as claimed in claim 9, wherein the fabric softening and/or conditioning compound is a liquid or soft solid derivative of a cyclic polyol (CPE) or of a reduced saccharide (RSE) resulting from 35 to 100% of the hydroxyl groups in the polyol or saccharide being esterified or etherified.

11. Fabric care composition comprising a polymer which is capable of self-cross-linking and/or of reacting with cellulose and a compound which is a liquid or soft solid derivative of a cyclic polyol (CPE) or of a reduced saccharide (RSE) resulting from 35 to 100% of the hydroxyl groups in the polyol or saccharide being esterified or etherified.

12. Composition as claimed in claim 11, wherein the polymer is a polymer having the features of any one of claims 4 to 6.

13. Composition as claimed in claim 11 or 12 which is suitable for use in the rinse cycle of a laundering process.

14. Method of treating fabric comprising applying to the fabric a composition of any one of claims 11 to 13.

15. Method as claimed in claim 14, wherein the composition is applied to the fabric during a laundering process.

16. Method as claimed in claim 15, wherein the composition is applied to the fabric during the rinse cycle of a laundering process.
